(19) United States
(12) Patent Application Publication
(10) Pub. No.: US 2026/0319719 A1
(43) Pub. Date: Oct. 15, 2026

(54) IMAGE FORMING APPARATUS AND CONTROL METHOD FOR IMAGE FORMING APPARATUS

(71) Applicant: SHARP KABUSHIKI KAISHA, Sakai City (JP)

(72) Inventor: Mitsunori OHYA, Sakai City (JP)

(21) Appl. No.: 19/466,670

(22) Filed: Feb. 2, 2026

(30) Foreign Application Priority Data
Feb. 3, 2025 (JP) 2025-015766

(51) Int. Cl. G06F 3/12

(52) U.S. Cl. CPC G06F 3/1219; G06F 3/1205; G06F 3/1208; G06F 3/1232; G06F 3/1252; G06F 3/1256

(57) ABSTRACT

An image forming apparatus includes a printer that performs printing on a sheet based on image data of a reading surface of a document as a reading target in printing, a notification provider that provides notification of print settings information, the print settings information being settable in the printer, and one or more controllers. The one or more controllers determine whether sheet-reduction printing is settable in the printer, the sheet-reduction printing meaning a printing operation in which the number of sheets required in the printing by the printer is smaller than the number of reading surfaces based on character information related to character data in the image data, and cause the notification provider to provide notification of the print settings information related to the settable sheet-reduction printing in a case where the one or more controllers determine that the sheet-reduction printing is settable.

### CROSS-REFERENCE TO RELATED APPLICATION

The present application claims priority from Japanese Application JP2025-015766, the content of which is hereby incorporated by reference into this application.

### BACKGROUND OF THE INVENTION

### 1. Field of the Invention

The disclosure relates to an image forming apparatus and a control method for an image forming apparatus.

### 2. Description of the Related Art

In the related art, an image forming apparatus capable of aggregating a plurality of pages included in a document divided into page units and printing the aggregated pages on a single page is disclosed. The image forming apparatus disclosed in the related art is configured such that a character size after the aggregation can be maintained at a size required by a user.

### SUMMARY

Incidentally, the image forming apparatus disclosed in the related art can aggregate a plurality of pages included in a document and print the aggregated pages on a single page, so that the number of sheets required for printing can be reduced.

However, in order to aggregate a plurality of pages included in a document and then print the aggregated pages on a single page, a user needs to set settings for this printing in advance on the image forming apparatus. Further, when the user sets the settings for this printing, the user needs to know in advance the number of pages of the document that can be aggregated into a single page, and the setting operation becomes complicated.

An object of an aspect of the disclosure is to provide an image forming apparatus and a control method for an image forming apparatus that can reduce the number of sheets required for printing without requiring a user to perform a complicated setting operation in advance.

An image forming apparatus according to an aspect of the disclosure includes a printer that performs printing on a sheet based on image data of a reading surface of a document as a reading target in printing, a notification provider that provides notification of print settings information, the print settings information being settable in the printer, and one or more controllers. The one or more controllers determine whether sheet-reduction printing is settable in the printer, the sheet-reduction printing meaning a printing operation in which the number of sheets required in the printing by the printer is smaller than the number of reading surfaces based on character information related to character data in the image data, and cause the notification provider to provide notification of the print settings information related to the settable sheet-reduction printing when the one or more controllers determine that the sheet-reduction printing is settable.

A control method for an image forming apparatus according to an aspect of the disclosure is a control method for an image forming apparatus including a printer that performs printing on a sheet based on image data of a reading surface of a document as a reading target in printing, and a notification provider that provides notification of print settings information, the print settings information being settable in the printer. The control method for the image forming apparatus includes determining whether sheet-reduction printing is settable in the printer, the sheet-reduction printing meaning a printing operation in which the number of sheets required in the printing by the printer is smaller than the number of reading surfaces based on character information related to character data in the image data, and causing the notification provider to provide notification of the print settings information related to the settable sheet-reduction printing when the one or more controllers determine that the sheet-reduction printing is settable.

According to an aspect of the disclosure, the image forming apparatus and the control method for the image forming apparatus can reduce the number of sheets required for printing without requiring a user to perform a complicated setting operation in advance.

### BRIEF DESCRIPTION OF THE DRAWINGS

FIG. 1 is a perspective view schematically illustrating an external appearance of an image forming apparatus according to an embodiment of the disclosure.

FIG. 2 is a block diagram illustrating an example of a configuration of main portions in the image forming apparatus according to the embodiment of the disclosure.

FIG. 3 is a table representing an example of a relationship between the number of reading surfaces and executable functions of print processing in the image forming apparatus according to the embodiment of the disclosure.

FIG. 4 is a table representing an example of a relationship between functions of print processing and print modes in the image forming apparatus according to the embodiment of the disclosure.

FIG. 5 is a diagram schematically illustrating an example of printing states when 1in1 printing, 2in1 printing, and 4in1 printing are performed on image data not including character data in the image forming apparatus according to the disclosure.

FIG. 6 is a diagram schematically illustrating an example of printing states when 1in1 printing, 2in1 printing, and 4in1 printing are performed on image data including character data in the image forming apparatus according to the disclosure.

FIG. 7 is a diagram schematically illustrating an example of printing states when 1in1 printing, 2in1 printing, and 4in1 printing are performed on image data including character data in the image forming apparatus according to the disclosure.

FIG. 8 is a diagram illustrating a display example of print settings information displayed on a display included in the image forming apparatus according to the embodiment of the disclosure.

FIG. 9 is a flowchart illustrating an example of print processing in the image forming apparatus according to the embodiment of the disclosure.

FIG. 10 is a diagram schematically illustrating an example of a printing state when a document (identification card) is printed on a sheet by using a function of identification card copying in an image forming apparatus according to a modification of the embodiment of the disclosure.

FIG. 11 is a table illustrating an example of a relationship between the number of reading surfaces and executable functions of print processing in the image forming apparatus according to the modification of the embodiment of the disclosure.

FIG. 12 is a flowchart illustrating an example of print processing of the image forming apparatus according to the modification of the embodiment of the disclosure.

FIG. 13 is a flowchart illustrating an example of setting processing for identification card copying, the setting processing being included in the print processing illustrated in FIG. 12.

FIG. 14 is a diagram illustrating a display example of print settings information displayed on a display included in the image forming apparatus according to the modification of the embodiment of the disclosure.

### DETAILED DESCRIPTION OF THE INVENTION

An embodiment and a modification of the disclosure will be described with reference to the accompanying drawings. Note that in the following description, the same or corresponding elements are denoted by the same reference signs or numerals throughout the drawings, and duplicated description thereof will be omitted. Further, the embodiment and the modification, which will be described below, are merely examples of the disclosure, and the disclosure is not limited to the embodiment and the modification. Even in cases other than the embodiment and the modification, various changes can be made according to design and the like without departing from the technical idea of the disclosure.

### Configuration of Image Forming Apparatus

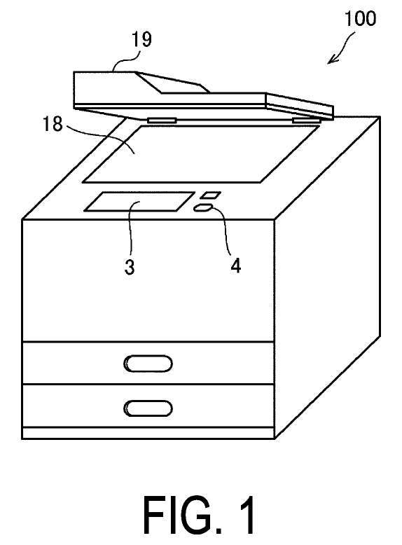

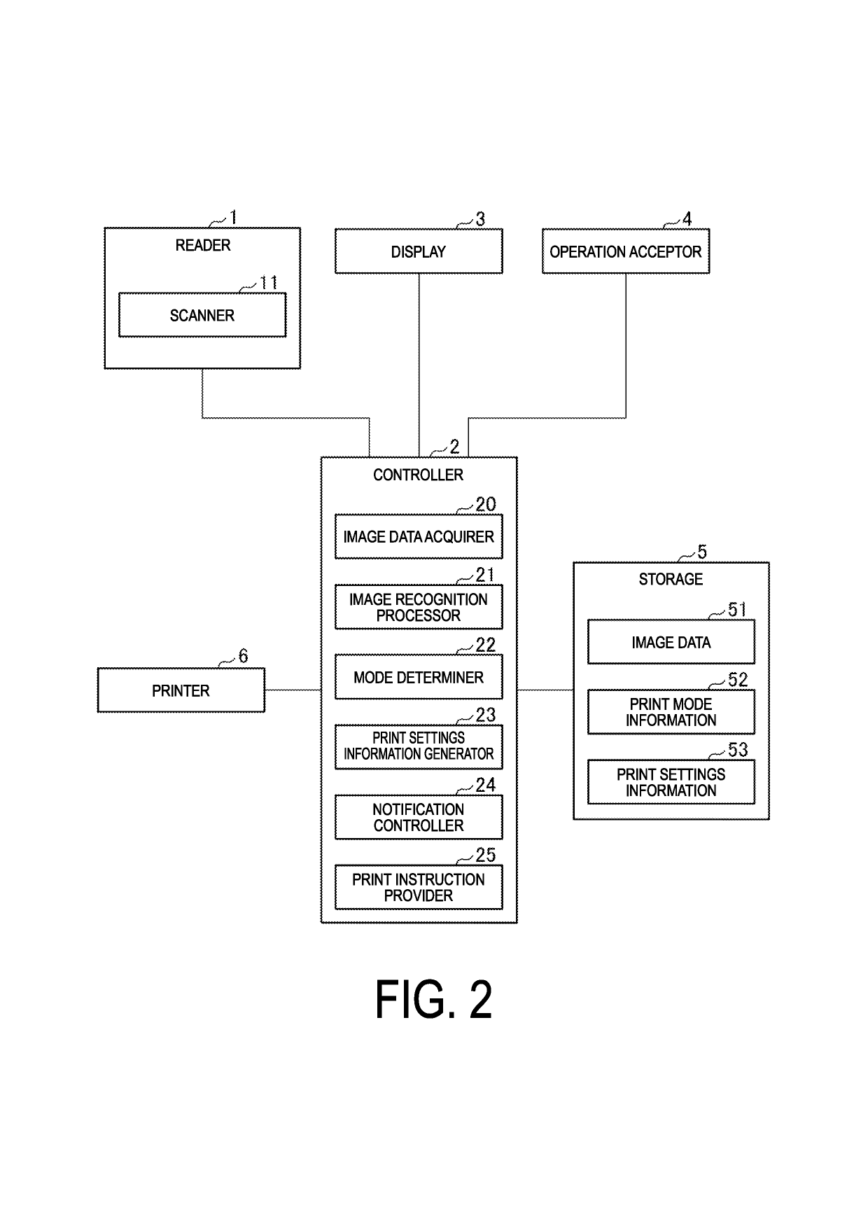

A configuration of an image forming apparatus 100 according to an embodiment of the disclosure will be described with reference to FIGS. 1 and 2. FIG. 1 is a perspective view schematically illustrating an external appearance of the image forming apparatus 100 according to the embodiment of the disclosure. FIG. 2 is a block diagram illustrating an example of a configuration of main portions in the image forming apparatus 100 according to the embodiment of the disclosure.

As illustrated in FIG. 1, the image forming apparatus 100 has a substantially rectangular parallelepiped shape as a whole, and a platen glass 18 is provided on an upper surface of the image forming apparatus 100, and a reader 1 is provided below the platen glass 18.

The reader 1 reads an image of a reading surface as a reading target at the time of printing from a document, and thus generates image data. As illustrated in FIG. 2, the reader 1 includes a scanner 11. The scanner 11 is configured to illuminate a document placed on the platen glass 18 and then to collect the reflected light onto a Charge Coupled Device (CCD) or the like to read an image. The reader 1 may be, for example, an Optical Character Reader (OCR).

Additionally, an automatic document feeder 19 is provided on the upper surface of the image forming apparatus 100 so as to cover the platen glass 18. The automatic document feeder 19 is connected to the upper surface of the image forming apparatus 100 by a hinge mechanism so as to be openable and closeable. The automatic document feeder 19 can automatically draw in and read each of a plurality of documents (a plurality of pages) that are set.

A display 3 (notification provider) is provided on the front side (user operation side) of the upper surface of the image forming apparatus 100. The display 3 is a display device such as a liquid crystal panel, and displays an operation menu screen of the image forming apparatus 100, a preview image, which will be described below, or the like.

In addition, operation buttons are provided as an operation acceptor 4 that receives an input from a user in the vicinity of the display 3. Examples of the operation buttons include a power button, a print start button, a print stop button, and numeric buttons of the image forming apparatus 100. In addition, when the display 3 functions as a touch panel, the display 3 may also function as the operation acceptor 4.

As illustrated in FIG. 2, the image forming apparatus 100 further includes a controller 2, a storage 5, and a printer 6 in addition to the reader 1, the display 3, and the operation acceptor 4 described above.

The controller 2 is a processing apparatus that performs various types of control of the respective units included in the image forming apparatus 100, and is configured by one or more controllers. For example, the controller 2 can be configured by a processor such as a Central Processing Unit (CPU). The controller 2 reads out and executes programs and data (not illustrated) stored in the storage 5, thereby performing various types of control of the respective units included in the image forming apparatus 100.

In other words, in the image forming apparatus 100, the controller 2 includes, as a main hardware configuration, a processor such as a CPU that operates in accordance with a program. The processor may be of any type as long as the processor can enable a function by executing a program. The processor is configured by a semiconductor integrated circuit, for example, one or more electronic circuits including an Integration Circuit (IC) or a Large Scale Integration (LSI). The plurality of electronic circuits may be integrated on one chip or may be provided on a plurality of chips. The plurality of chips may be integrated into one apparatus or may be included in a plurality of apparatuses. Details of the controller 2 will be described below.

The storage 5 may be a storage device such as a Random Access Memory (RAM), a Read Only Memory (ROM), a Hard Disk Drive (HDD), or a Solid State Drive (SSD). The storage 5 stores image data 51, print mode information 52, and print settings information 53 in addition to the above-described programs and data.

The image data 51 is data of an image read by the reader 1 on a reading surface as a print target.

The print mode information 52 is information indicating a print mode set according to the degree of suppression of the number of discharged sheets on which images are printed. Specifically, the print mode information 52 includes information indicating a print mode such as a High mode, a Middle mode, and a Low mode.

The High mode is a print mode in which printing is performed so as to minimize the number of discharged sheets by combining functions of the print processing of the image forming apparatus 100.

The Low mode is a print mode in which an image is printed on a single sheet for each reading surface.

The Middle mode is a print mode in which the number of discharged sheets is smaller than that in the Low mode and larger than that in the High mode.

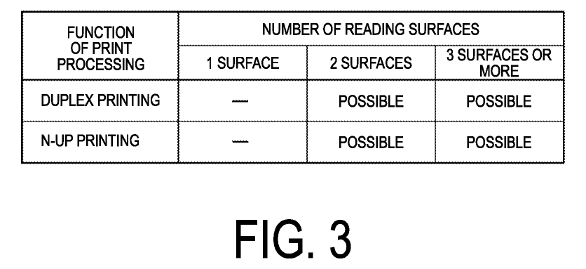

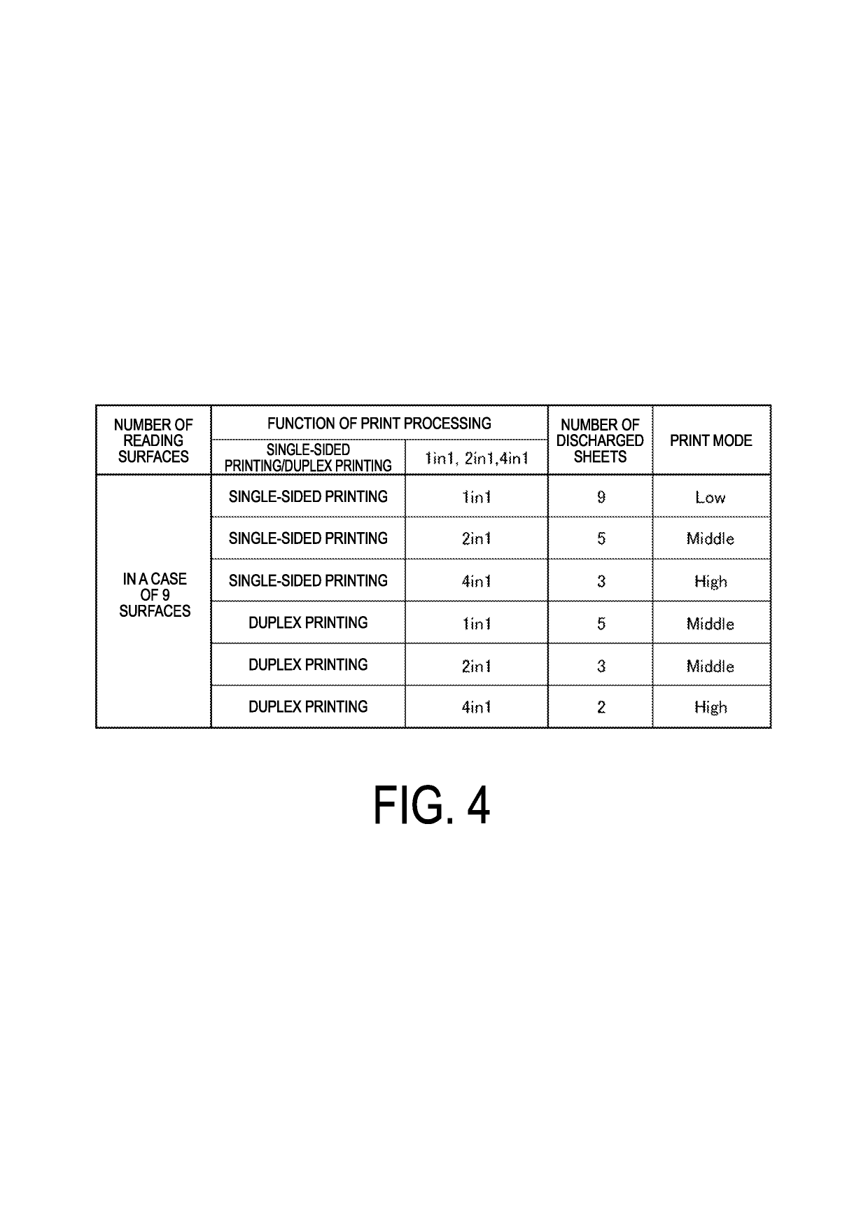

Here, the High mode, the Middle mode, and the Low mode will be described in more detail with reference to FIGS. 3 and 4. FIG. 3 is a table representing an example of a relationship between the number of reading surfaces and executable functions of the print processing in the image forming apparatus 100 according to the embodiment of the disclosure. FIG. 4 is a table representing an example of a relationship between functions of the print processing and print modes in the image forming apparatus 100 according to the embodiment of the disclosure.

First, a case where the image forming apparatus 100 has the executable functions of the print processing including duplex printing and N-up printing and performs printing on a sheet based on the image data 51 read from each of nine reading surfaces will be described herein as an example. The N-up printing is to print images of two or more reading surfaces on the same surface (front surface or back surface) of a sheet by reducing the images in size. Note that as illustrated in FIG. 3, in order for the image forming apparatus 100 to perform the duplex printing and the N-up printing, the number of reading surfaces needs to be two or more. It should be also noted that in FIG. 3, the number of reading surfaces on which the duplex printing and the N-up printing can be performed is represented as "possible".

As illustrated in FIG. 4, in a case of 1in1 printing in which printing is performed on one surface of a sheet so as to correspond to one piece of the image data 51 read out from each reading surface, the print mode is the Low mode. In the Low mode, the number of discharged sheets is nine.

In a case of 2in1 printing in which printing is performed on one surface of a sheet based on two pieces of the image data 51 read out from two reading surfaces, the print mode is the Middle mode. In the Middle mode, the number of discharged sheets is five.

In a case of 4in1 printing in which printing is performed on one surface of a sheet based on four pieces of the image data 51 read out from the four reading surfaces, the print mode is the High mode. In the High mode, the number of discharged sheets is three.

In addition to the above-described N-up printing, duplex printing can be combined. As illustrated in FIG. 4, when 1in1 printing is performed on each of the front and back surfaces of a sheet, the print mode is the Middle mode. In the Middle mode, the number of discharged sheets is five.

Alternatively, when 2in1 printing is performed on each of the front and back surfaces of a sheet, the print mode can also be set to the Middle mode. In the Middle mode, the number of discharged sheets is three.

When 4in1 printing is performed on each of the front and back surfaces of a sheet, the print mode is the High mode. In the High mode, the number of discharged sheets is two.

The print settings information 53 is settings information related to the print processing, the setting information being set in the printer 6. More specifically, the print settings information 53 is information related to sheet-reduction printing that can be set in the printer 6. Note that the sheet-reduction printing is printing in which the number of sheets on which images are printed is set to be smaller than the number of reading surfaces that are a print target and that are read from a document. The sheet-reduction printing may be, for example, N-up printing, duplex printing, or the like. Examples of the N-up printing include 2in1 printing in which images of two reading surfaces are printed on one sheet, and 4in1 printing in which images of four reading surfaces are printed on one sheet. The print settings information 53 also includes information indicating a print result when printing is performed by the sheet-reduction printing that can be set in the printer 6. Examples of the information indicating the print result include a preview image generated by simulating the print result when the image forming apparatus 100 performs the sheet-reduction printing.

The printer 6 prints an image on a sheet based on the image data 51. The printer 6 can print an image on a sheet by, for example, an electrophotographic method. The printer 6 includes development devices, photoreceptor drums, drum cleaning devices, chargers, and the like, which are not illustrated. The printer 6 forms toner images of the respective colors on the surfaces of the respective photoreceptor drums, transfers and superimposes the formed toner images onto an intermediate transfer belt, transfers the superimposed toner images onto a sheet and then performs thermal fixation, thereby printing an image on the sheet. Note that the printer 6 is not limited to the configuration that performs printing by the electrophotographic method described above, and may be configured to print an image on a sheet by another method such as an inkjet method.

### Configuration of Controller Related to Print Processing

As illustrated in FIG. 2, the controller 2 includes, as functional blocks related to the print processing, an image data acquirer 20, an image recognition processor 21, a mode determiner 22, a print settings information generator 23, a notification controller 24, and a print instruction provider 25. When the controller 2 is, for example, a CPU, the CPU reads out a program from the storage 5 and executes the program to implement these units.

The image data acquirer 20 acquires the image data 51 read from a document by the reader 1 and stores the acquired image data 51 in the storage 5. Furthermore, the image data acquirer 20 may acquire the image data 51 from an external Personal Computer (PC) or the like via a network, or may access a portable memory or the like to acquire the image data 51.

The image recognition processor 21 performs character recognition processing on the image data 51 acquired by the image data acquirer 20.

The mode determiner 22 extracts character information related to the character data in the image data 51 based on the processing result of the character recognition processing by the image recognition processor 21. Then, the mode determiner 22 determines whether the sheet-reduction printing can be set in the printer 6 based on the extracted character information. Further, when the mode determiner 22 determines that the sheet-reduction printing can be set, the mode determiner 22 determines a settable print mode.

Note that the character information includes information indicating whether character data is included in the image data 51, and information regarding a character size when character data is included.

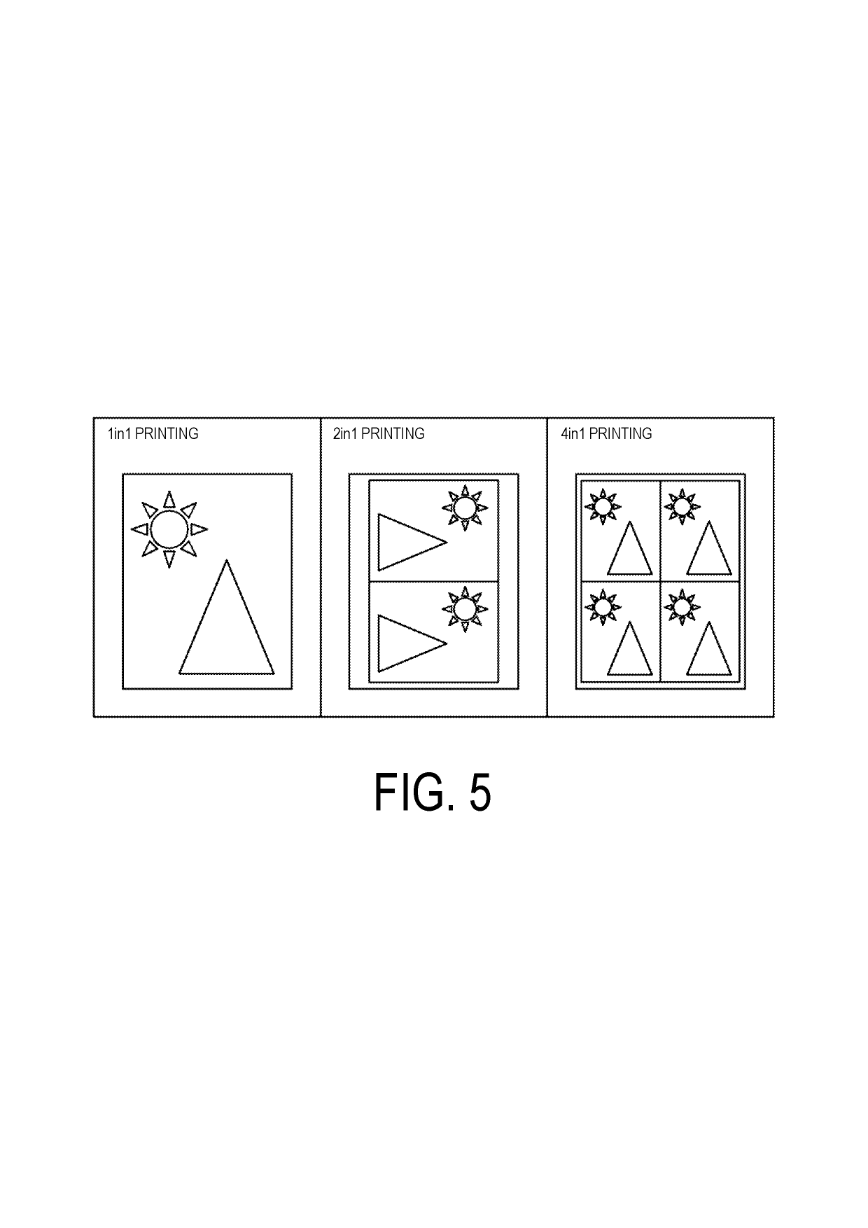

That is, when the image data 51 does not include character data, for example, when the image data 51 includes only a photographic image, a user can visually recognize the image even in a case where 4in1 printing is performed as illustrated in FIG. 5. FIG. 5 is a diagram schematically illustrating an example of printing states when the image data 51 not including character data is subjected to 1in1 printing, 2in1 printing, and 4in1 printing, in the image forming apparatus 100 of the disclosure.

Thus, when the image data 51 does not include character data, the mode determiner 22 determines that the N-up printing can be set as the sheet-reduction printing. Further, the mode determiner 22 determines that the settable print mode is the High mode.

On the other hand, when the image data 51 includes character data, the mode determiner 22 determines whether the N-up printing can be set based on whether the character size of the character data is smaller than a predetermined size. Note that the predetermined size is a size that enables a user to visually recognize characters when the characters are reduced in size by the N-up printing based on character data and are printed on a sheet.

After that, when the mode determiner 22 determines that the N-up printing can be set, the mode determiner 22 determines whether the 2in1 printing can be performed or whether the 4in1 printing can be performed, and determines a settable print mode.

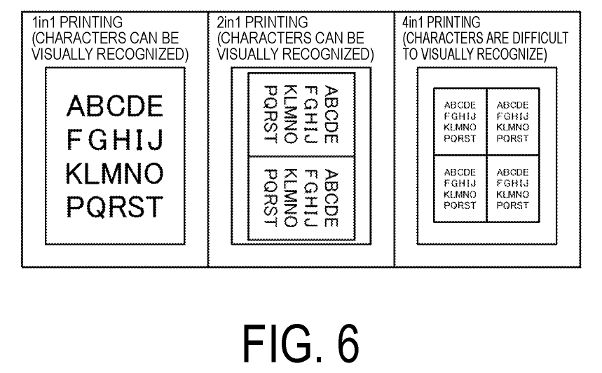

For example, as illustrated in FIG. 6, in the case of the 4in1 printing, the size of the characters (A, B, C, ...) printed on the sheet is difficult for the user to visually recognize, but in the case of the 2in1 printing, when the size of the characters can be visually recognized by the user, the mode determiner 22 determines that the settable print mode is the Middle mode.

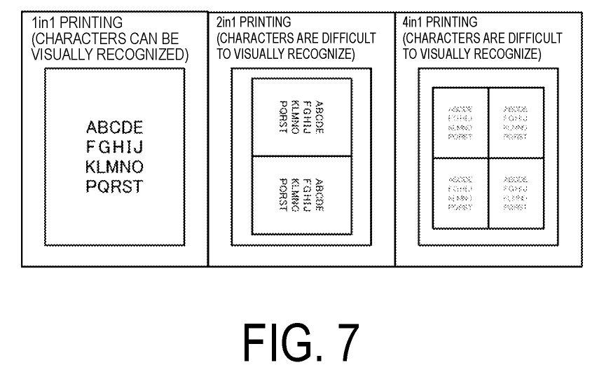

Further, as illustrated in FIG. 7, in both the 4in1 printing and the 2in1 printing, when the size of the characters to be printed on the sheet is a size that is difficult for the user to visually recognize, the mode determiner 22 determines that only the 1in1 printing is possible.

Here, when the image forming apparatus 100 has a function of duplex printing, the mode determiner 22 determines that the Middle mode in which the 1in1 printing is performed on both the front and back surfaces of a sheet is a settable print mode. When the image forming apparatus 100 has only a function of single-sided printing, the mode determiner 22 determines that the Low mode in which the 1in1 printing is performed on the front surface of a sheet is a settable print mode.

Each of FIGS. 6 and 7 is a diagram schematically illustrating an example of printing states when the image data 51 including character data is subjected to the 1in1 printing, the 2in1 printing, and the 4in1 printing, in the image forming apparatus 100 of the disclosure.

Note that the character size that is difficult for the user to visually recognize may be, for example, less than 6 points (about 2.12 mm). In this case, when the smallest size of characters included in the image data 51 is less than 6 points in the printing state, the mode determiner 22 determines that the character size is difficult for the user to visually recognize.

Alternatively, the mode determiner 22 extracts a vertical size or a horizontal size of the character having the smallest size in the image data 51. Then, the mode determiner 22 may be configured to determine that the character size is difficult for the user to visually recognize when the 2in1 printing is performed, in a case where a value obtained by multiplying the extracted size by a reduction ratio in the 2in1 printing is smaller than a predetermined threshold value. Further, the mode determiner 22 may be configured to determine that the character size is difficult for the user to visually recognize when the 4in1 printing is performed, in a case where a value obtained by multiplying the extracted size by a reduction ratio in the 4in1 printing is smaller than a predetermined threshold value.

In such a configuration, it is preferable that the threshold value can be set for each user. For example, in the image forming apparatus 100, table information of a threshold value set for each user may be stored in the storage 5, and the mode determiner 22 may refer to the table information when the character size is determined. In this way, in the case of the configuration in which the threshold value can be set for each user, the mode determiner 22 can determine the character size that is difficult to visually recognize in consideration of individual differences in character recognition.

Thus, the mode determiner 22 can determine whether the sheet-reduction printing can be set in the printer 6 based on the character information related to the character data in the image data 51. Further, when the mode determiner 22 determines that the sheet-reduction printing can be set, the mode determiner 22 can determine the settable print mode. The determination result by the mode determiner 22 is stored in the storage 5 as the print mode information 52.

However, as illustrated in FIG. 3, when the number of reading surfaces read by the reader 1 is one, the duplex printing and the N-up printing cannot be performed. Considering this fact, the mode determiner 22 also determines whether the number of reading surfaces read by the reader 1 is larger than one at the time of actual printing of a document.

The print settings information generator 23 generates the print settings information 53 based on the print mode information 52. The print settings information generator 23 stores the generated print settings information 53 in the storage 5.

The notification controller 24 notifies the user of the print settings information 53 stored in the storage 5. That is, the notification controller 24 controls the display 3 to display the print settings information 53. Specifically, the notification controller 24 performs the following display on the display 3.

That is, when the mode determiner 22 determines that the High mode is a settable print mode, the notification controller 24 causes the display 3 to display a preview image for printing in the High mode, a preview image for printing in the Middle mode, and a preview image for printing in the Low mode.

Additionally, when the mode determiner 22 determines that the Middle mode is a settable print mode, the notification controller 24 causes the display 3 to display a preview image for printing in the Middle mode and a preview image for printing in the Low mode.

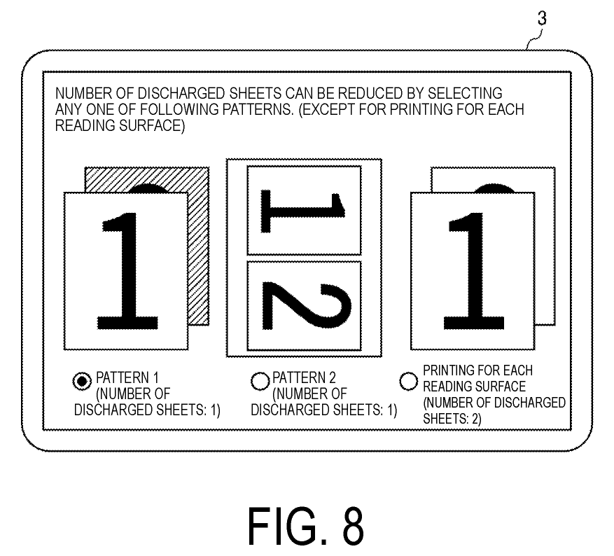

Here, the display of the print settings information 53 on the display 3 will be described by taking, as an example, a case where the number of reading surfaces read by the reader 1, that is, the number of times of data reading by the reader 1 satisfies N = 2, and the settable print mode is the Middle mode. In this case, the notification controller 24 can cause the display 3 to display a preview image as illustrated in FIG. 8. FIG. 8 is a diagram illustrating a display example of the print settings information 53 displayed on the display 3 included in the image forming apparatus 100 according to the embodiment of the disclosure.

As illustrated in FIG. 8, the notification controller 24 causes the display 3 to display, as preview images for printing in the Middle mode, a preview image (pattern 1) for the 1in1 printing on the front and back surfaces of a sheet and a preview image (pattern 2) for the 2in1 printing on the front surface of a sheet. Further, the notification controller 24 causes the display 3 to display, as a preview image for printing in the Low mode, a preview image for the 1in1 printing on the front surface of each sheet with each reading surface unchanged (printing for each reading surface). For example, the user may want to print an image unchanged without reduction in size depending on a print target. For this case, the notification controller 24 also causes the display 3 to display a preview image in a case of performing the 1in1 printing on the front surface of each sheet.

In this manner, the preview image is an image from which the number of sheets to be printed by the printer 6 and the surface of a sheet to be printed by the printer 6 can be recognized.

The notification controller 24 also causes the display 3 to display the number of sheets (the number of discharged sheets) discharged in printing of a pattern 1, printing of a pattern 2, and printing of each reading surface, respectively, in association with each print pattern.

The notification controller 24 also causes the display 3 to display a message for prompting the user to select a print mode, such as "The number of discharged sheets can be reduced by selecting any one of the following options". That is, the notification controller 24 causes the display 3 to display the preview images of the settable print modes in a state where the user can select a print mode. However, when printing is performed for each reading surface, the number of discharged sheets is not reduced, and thus, a notification indicating that the number of discharged sheets cannot be reduced is displayed.

The print instruction provider 25 instructs the printer 6 to execute printing based on a selection instruction from the user received through the operation acceptor 4.

That is, the user selects a print pattern by operating the operation acceptor 4 with reference to the display on the display 3. The print instruction provider 25 receives a selection instruction related to print patterns from the user through the operation acceptor 4. Then, the print instruction provider 25 controls the printer 6 to perform printing according to the print pattern selected by the user based on the selection instruction received from the user.

As described above, the image forming apparatus 100 can cause the display 3 to display the preview image related to the print pattern of the settable print mode to notify the user of the preview image. Thus, the image forming apparatus 100 can reduce the number of sheets required for printing without requiring the user to perform complicated setting operations in advance.

The image forming apparatus 100 causes not only the preview image to be printed in the Middle mode as described above but also the preview image to be printed in the Low mode to be displayed. Thus, even when printing can be performed in the Middle mode, the image forming apparatus 100 can cause the user to select printing in the Low mode depending on the printing state indicated in the preview image.

Further, when a plurality of preview images are present and all the preview images cannot be displayed on the display 3, the notification controller 24 may be configured to preferentially cause the display 3 to display a preview image of a print pattern having the smaller number of sheets to be printed by the printer 6.

Additionally, as described above, the image forming apparatus 100 is configured such that the mode determiner 22 can automatically determine and set the print mode that can be set in the printer 6 based on the character information in the image data 51. The image forming apparatus 100 may be further configured such that the user can manually set the print mode through the operation acceptor 4.

### Print Processing in Image Forming Apparatus

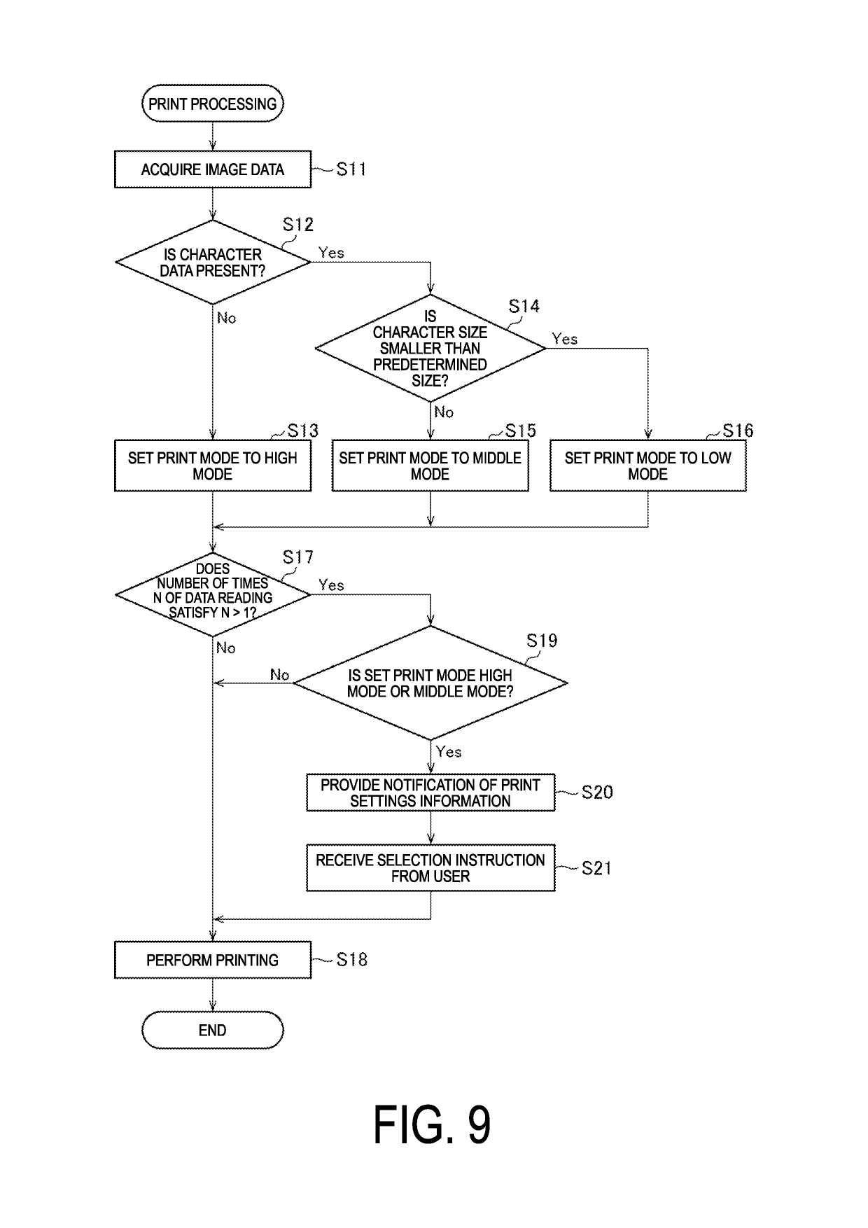

Next, print processing in the image forming apparatus 100 according to the embodiment will be described with reference to FIG. 9. FIG. 9 is a flowchart illustrating an example of print processing in the image forming apparatus 100 according to the embodiment of the disclosure. Note that in FIG. 9, for convenience of description, a case of performing single-sided printing will be described as an example.

First, the image forming apparatus 100 is set with a document and the power thereof is turned on. Then, a user operates the operation acceptor 4 and provides an instruction of execution start of the print processing. As described above, when the execution start of the print processing is instructed, the reader 1 reads an image from a document and generates image data 51. The image data acquirer 20 acquires the image data 51 generated in this manner (step S11). Then, the image data acquirer 20 stores the acquired image data 51 in the storage 5. Further, the image recognition processor 21 executes character recognition processing on the image data 51 acquired by the image data acquirer 20.

Next, the mode determiner 22 determines whether character data is present in the image data 51 (step S12). The mode determiner 22 scans all the image data 51 read by the reader 1, and determines the presence or absence of character data based on the result of the character recognition processing by the image recognition processor 21.

When the mode determiner 22 determines that the image data 51 does not include character data ("No" in step S12), the mode determiner 22 sets the High mode as a settable print mode (step S13).

On the other hand, when the mode determiner 22 determines that the image data 51 includes character data ("Yes" in step S12), the mode determiner 22 determines whether the character size of the character data is smaller than a predetermined size (step S14). The predetermined size is a character size that allows the user to easily visually recognize when the 2in1 printing is performed on a sheet based on the image data 51, and may be, for example, 6 points.

When the mode determiner 22 determines that the character size of the character data is equal to or larger than the predetermined size ("No" in step S14), the Middle mode is set as a settable print mode (step S15).

On the other hand, when the mode determiner 22 determines that the character size of the character data is smaller than the predetermined size ("Yes" in step S14), the Low mode is set as a settable print mode (step S16). The mode determiner 22 stores the set print mode as the print mode information 52 in the storage 5.

As described above, in the image forming apparatus 100, the mode determiner 22 sets the settable print mode based on the image data 51 acquired by the image data acquirer 20.

Next, the mode determiner 22 determines whether the number of times N of data reading by the reader 1 is larger than 1 (step S17). The case where the number of times N of data reading is not larger than 1 ("No" in step S17) is a case where the number of times N of data reading is 1. In a case where the number of times N of data reading is 1, even when the High mode or the Middle mode is set as a settable print mode, the 4in1 printing or the 2in1 printing cannot be performed. Thus, when the determination result in step S17 is "No", the print instruction provider 25 instructs the printer 6 to perform the 1in1 printing on a sheet based on the image data 51. The printer 6 executes printing based on the instruction from the print instruction provider 25 (step S18).

On the other hand, when the mode determiner 22 determines that the number of times N of data reading by the reader 1 is larger than 1 ("Yes" in step S17), the mode determiner 22 determines whether the set print mode is the High mode or the Middle mode based on the print mode information 52 stored in the storage 5 (step S19).

Here, the case where the set print mode is neither the High mode nor the Middle mode ("No" in step S19) is a case where the set print mode is the Low mode. Thus, when the determination result is "No" in step S19, the controller 2 controls the printer 6 to perform the 1in1 printing on a sheet based on the image data 51 (step S18).

On the other hand, in a case of "Yes" in step S19, the print settings information generator 23 generates print settings information 53 based on the print mode information 52. The print settings information generator 23 stores the generated print settings information 53 in the storage 5. Then, the notification controller 24 notifies the user of the print settings information 53 stored in the storage 5 (step S20).

Then, the print instruction provider 25 receives a selection instruction related to print patterns from the user through the operation acceptor 4 (step S21). Then, the print instruction provider 25 instructs the printer 6 to perform printing according to the print pattern selected by the user based on the selection instruction received from the user. Then, the printer 6 executes printing based on the instruction from the print instruction provider 25 (step S18).

### Modification

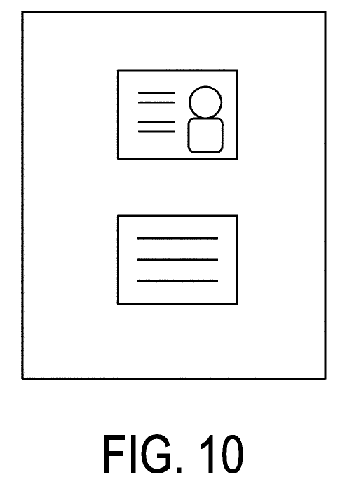

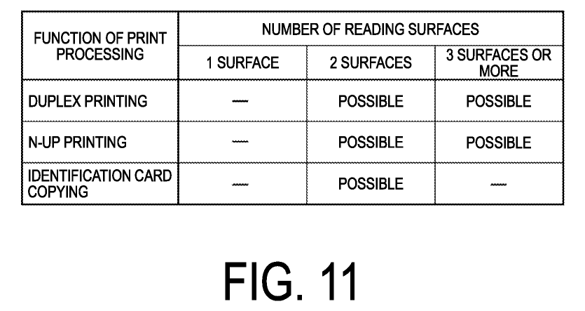

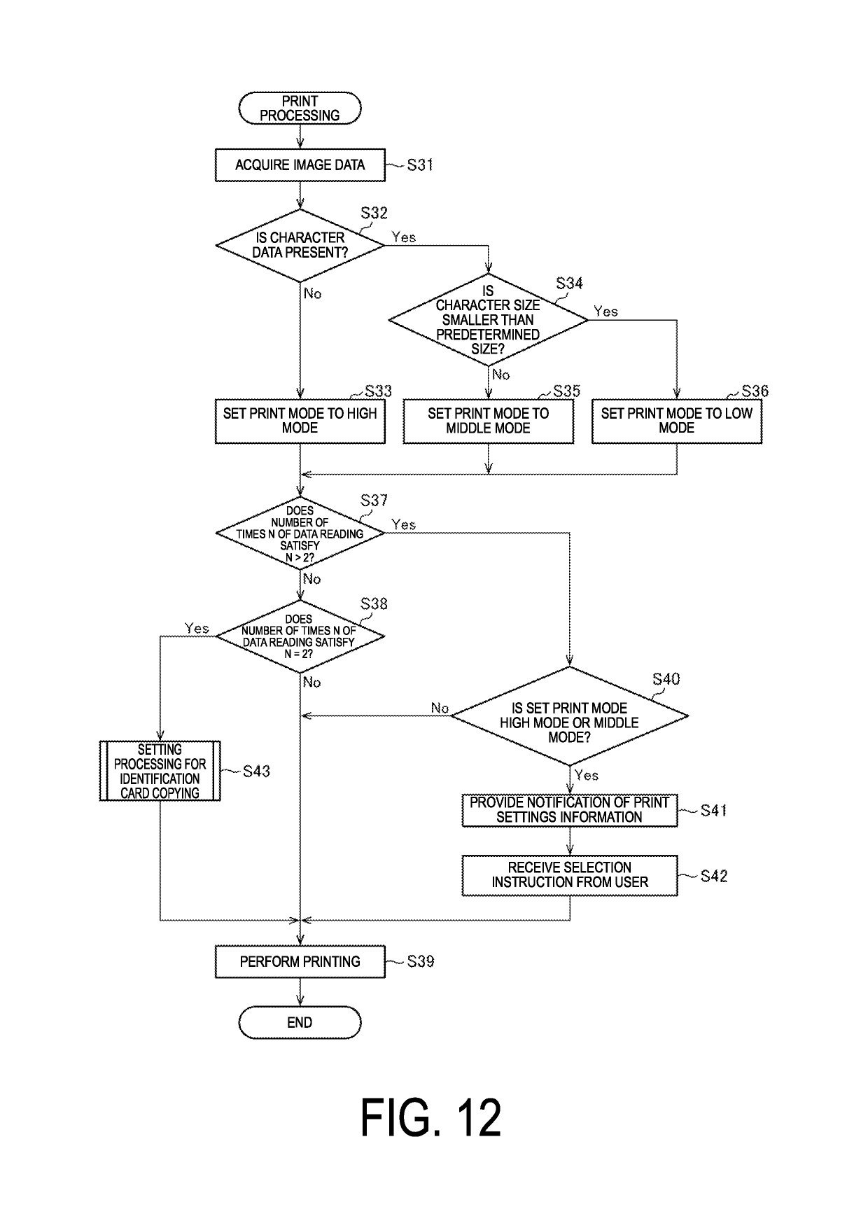

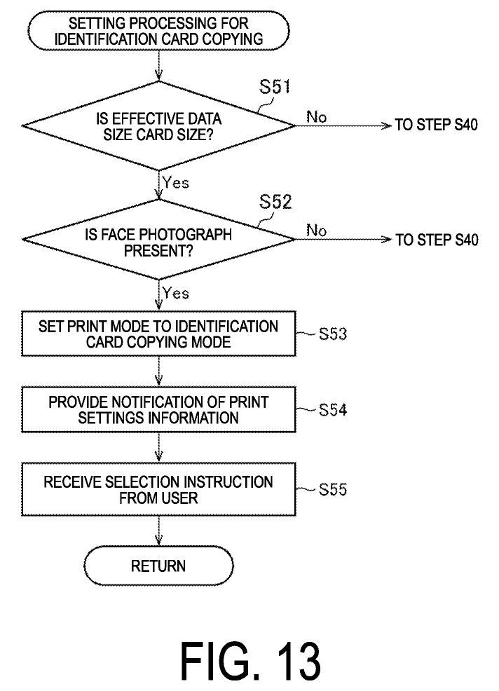

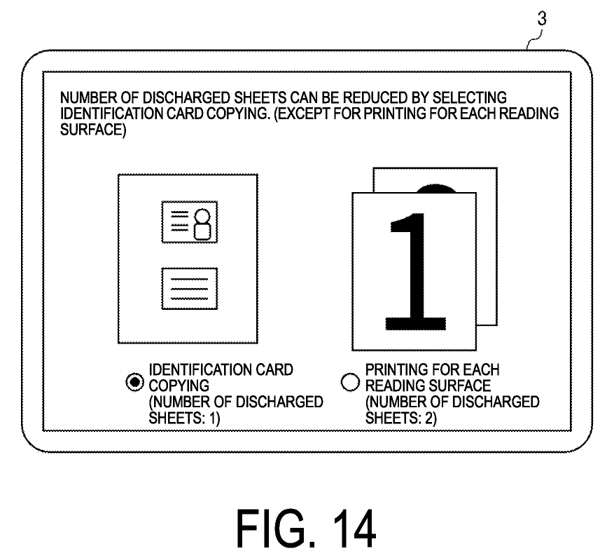

Next, a configuration of an image forming apparatus 100 according to a modification of the embodiment will be described with reference to FIG. 10 to FIG. 14. FIG. 10 is a diagram schematically illustrating an example of a printing state when a document (identification card) is printed on a sheet by using a function of identification card copying in the image forming apparatus 100 according to the modification of the embodiment of the disclosure. FIG. 11 is a table illustrating an example of a relationship between the number of reading surfaces and executable functions of print processing in the image forming apparatus 100 according to the modification of the embodiment of the disclosure. FIG. 12 is a flowchart illustrating an example of the print processing in the image forming apparatus 100 according to the modification of the embodiment of the disclosure. Note that in FIG. 12, for convenience of description, a case of performing single-sided printing will be described as an example. FIG. 13 is a flowchart illustrating an example of setting processing for identification card copying, the setting processing being included in the print processing illustrated in FIG. 12. FIG. 14 is a diagram illustrating a display example of the print settings information 53 displayed on the display 3 included in the image forming apparatus 100 according to the modification of the embodiment of the disclosure.

The image forming apparatus 100 according to the modification of the embodiment is different from the image forming apparatus 100 according to the embodiment in that the image forming apparatus 100 according to the modification of the embodiment is configured to be capable of further executing identification card copying as a function of the print processing. The image forming apparatus 100 according to the modification of the embodiment has a configuration similar to that of the image forming apparatus 100 according to the embodiment, except that the number of types of executable functions of the print processing is increased. According to this, in the image forming apparatus 100 according to the modification of the embodiment, members similar to those of the image forming apparatus 100 according to the embodiment are denoted by similar reference signs or numerals, and description thereof will be omitted.

Note that identification card copying is a function of copying a document having a card size such as a driver's license or an employee identification with both reading surfaces of the front and back surfaces of the document aligned on one sheet, as illustrated in FIG. 10. Although FIG. 10 illustrates an example in which the front and back surfaces of the document (identification card) are vertically aligned on a vertically long sheet and printed, the front and back surfaces of the document (identification card) may be horizontally aligned on a horizontally long sheet and printed.

That is, identification card copying is sheet-reduction printing in which the reading surfaces of the front and back surfaces of the document (identification card) are printed on one surface of a sheet without reduction in size while the vertical and horizontal directions of the reading surfaces of the front and back surfaces of the document are matched with each other based on pieces of image data of the reading surfaces of the front and back surfaces of the document. As illustrated in FIG. 11, the identification card copying can be executed only when the number of reading surfaces is two. Note that in FIG. 11, the number of reading surfaces that can be subjected to the duplex printing, the N-up printing, and the identification card copying is represented as "possible".

### Print Processing in Image Forming Apparatus According to Modification

Next, print processing in the image forming apparatus 100 according to the modification of the embodiment will be described with reference to FIGS. 12 to 14.

First, the image forming apparatus 100 according to the modification is set with a document, and the power thereof is turned on. Then, a user operates the operation acceptor 4 and provides an instruction of execution start of the print processing. As described above, when the execution start of the print processing is instructed, the reader 1 reads an image from a document and generates image data 51. The image data acquirer 20 acquires the image data 51 generated in this manner (step S31). Note that subsequent step S32 to step S36 are similar to step S12 to step S16 illustrated in FIG. 9, and thus, description thereof will be omitted.

In the image forming apparatus 100 according to the modification, after the mode determiner 22 sets a settable print mode for the image data 51 acquired by the image data acquirer 20, the mode determiner 22 detects the number of times N of data reading by the reader 1 and determines whether the number of times N of data reading is larger than 2 (step S37).

When the mode determiner 22 determines that the number of times N of data reading is larger than 2 ("Yes" in step S37), the processing proceeds to step S40. Processing of step S40 and subsequent steps, that is, processing from step S40 to step S42 and processing up to step S39 are similar to the processing from step S19 to step S21 and the processing up to step S18 illustrated in FIG. 9, and thus, description thereof will be omitted.

When the number of times N of data reading is equal to or less than 2 ("No" in step S37), the mode determiner 22 determines whether the number of times N of data reading is 2 (step S38).

When the mode determiner 22 determines that the number of times N of data reading is not 2 ("No" in step S38), the number of times N of data reading is 1. Thus, when the determination result is "No" in step S38, the print instruction provider 25 instructs the printer 6 to perform the 1in1 printing on a sheet based on the image data 51. The printer 6 executes printing based on the instruction from the print instruction provider 25 (step S39).

On the other hand, when the number of times N of data reading is 2 ("Yes" in step S38), the document may be an identification card. Then, the processing proceeds to step S43, and setting processing for the identification card copying is executed.

The setting processing for the identification card copying will be described below with reference to FIG. 13. First, the mode determiner 22 determines whether the document of the image data 51 acquired by the image data acquirer 20 is an identification card. Specifically, it is determined whether an effective data size, based on the image data 51, is a card size (step S51).

The effective data size is a size of the reading surface of the document to be actually printed. That is, the reader 1 scans the entire range of the A4 size to read an image from the document. At this time, the mode determiner 22 performs image processing such as edge detection on the image read by the reader 1, and detects the size of the reading surface to be actually printed, that is, the effective data size. Then, the mode determiner 22 determines whether the detected effective data size is the card size. Note that the card size may be, for example, 54 mm high and 85.6 mm wide, which is a size of the JIS standard.

When the mode determiner 22 determines that the effective data size is not the card size ("No" in step S51), the mode determiner 22 determines that the document is not an identification card. Then, the processing proceeds to step S40.

On the other hand, when the mode determiner 22 determines that the effective data size is the card size ("Yes" in step S51), the mode determiner 22 determines whether an image of a face photograph is included in at least one of pieces of the image data 51 of the two reading surfaces read by the reader 1 (step S52).

When the mode determiner 22 determines that no image of a face photograph is included in the pieces of the image data 51 of the two reading surfaces read by the reader 1 ("No" in step S52), the mode determiner 22 determines that the document is not an identification card. Then, the processing proceeds to step S40.

On the other hand, when the mode determiner 22 determines that at least one of the pieces of image data 51 of the two reading surfaces read by the reader 1 includes an image of the face photograph ("Yes" in step S52), the mode determiner 22 determines that the document is an identification card. Then, the processing proceeds to step S53, and the mode determiner 22 sets an identification card copying mode (step S53). After that, the mode determiner 22 stores the identification card copying mode as the print mode information 52 in the storage 5. Note that the identification card copying mode is a print mode in which printing is performed using the identification card copying described above.

Then, the print settings information generator 23 generates the print settings information 53 based on the print mode information 52. The print settings information generator 23 stores the generated print settings information 53 in the storage 5. The notification controller 24 notifies the user of the print settings information 53 stored in the storage 5 (step S54). That is, the notification controller 24 controls the display 3 to display the print settings information 53.

Here, the print settings information 53 displayed on the display 3 is, for example, an image as illustrated in FIG. 14. That is, the display 3 displays, as a preview image in the case of printing in the identification card copying mode, a preview image (identification card copy) in a case of printing the images of the respective reading surfaces of the front and back surfaces of the document (identification card) on the front surface of a sheet by vertically aligning the images without reduction in size. Further, as a preview image in the case of printing in the Low mode, a preview image (printing for each reading surface) in a case of performing the 1in1 printing on the front surface of each sheet in a state where each reading surface is unchanged is displayed.

Moreover, the display 3 also displays the number of sheets (the number of discharged sheets) to be discharged in each of the identification card copying and the printing for each reading surface in association with each other.

In this manner, the preview image is an image from which the number of sheets to be printed by the printer 6 and the surface of a sheet to be printed by the printer 6 can be recognized.

The notification controller 24 also controls the display 3 to display a message for prompting the user to select the identification card copying, such as "The number of discharged sheets can be reduced by selecting identification card copying". That is, the notification controller 24 causes the preview images of the settable print modes to be displayed in a state in which the user can select a print mode.

The print instruction provider 25 receives a selection instruction related to a print pattern from the user through the operation acceptor 4 (step S55). Then, the print instruction provider 25 instructs the printer 6 to execute printing based on the selection instruction from the user received through the operation acceptor 4 (step S39).

As described above, the image forming apparatus 100 according to the modification determines whether a document is an identification card, and when it is determined that the document is an identification card, the image forming apparatus 100 can cause the display 3 to display the preview image of the identification card copying mode to notify a user of the preview image. Accordingly, the image forming apparatus 100 according to the modification can reduce the number of sheets required for printing without requiring the user to perform complicated setting operations in advance even when the document is an identification card.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An image forming apparatus comprising:
a printer that performs printing on a sheet based on image data of a reading surface of a document as a reading target in printing;
a notification provider that provides notification of print settings information, the print settings information being settable in the printer; and
one or more controllers, wherein
the one or more controllers
determine whether sheet-reduction printing is settable in the printer, the sheet-reduction printing meaning a printing operation in which the number of sheets required in the printing by the printer is smaller than the number of reading surfaces based on character information related to character data in the image data, and
cause the notification provider to provide notification of the print settings information related to the settable sheet-reduction printing in a case where the one or more controllers determine that the sheet-reduction printing is settable.

2. The image forming apparatus according to claim 1, wherein
the print settings information includes information indicating a print result in a case where the printer performs printing based on the image data by the settable sheet-reduction printing.

3. The image forming apparatus according to claim 1, wherein
the one or more controllers control the notification provider to display the print settings information in a selectable state by a user and thus to provide notification of the print settings information.

4. The image forming apparatus according to claim 1, wherein,
in a case where the one or more controllers determine that the image data does not include the character data, the one or more controllers determine that N-up printing that performs printing based on image data of two or more of the reading surfaces on the same surface of the sheet is settable as the sheet-reduction printing.

5. The image forming apparatus according to claim 1, wherein,
in a case where the image data includes the character data having a predetermined character size or larger, the one or more controllers determine that N-up printing is settable as the sheet-reduction printing, the N-up printing meaning a printing operation in which images of two or more of the reading surfaces are reduced in size and printed on the same surface of the sheet.

6. The image forming apparatus according to claim 5, wherein
the predetermined character size is a size at which a character is visually recognizable by a user in a case where the character is reduced and printed on the sheet by the N-up printing based on the character data.

7. The image forming apparatus according to claim 1, wherein
in a case where the one or more controllers determine that a plurality of setting types of the sheet-reduction printing are settable, the one or more controllers control the notification provider to preferentially provide notification of the print settings information in which the number of sheets to be printed by the printer is small among a plurality of pieces of the print settings information corresponding one-to-one to the plurality of setting types of the sheet-reduction printing.

8. The image forming apparatus according to claim 7, wherein
the print settings information includes at least one of information related to the number of sheets to be printed by the printer and information related to a surface of the sheet to be printed by the printer.

9. The image forming apparatus according to claim 1, wherein
the one or more controllers further determine whether the document is an identification card based on the image data, and
in a case where the one or more controllers determine that the document is the identification card, the one or more controllers determine that identification card copying is settable as the sheet-reduction printing, the identification card copying meaning a printing operation in which printing is performed on one surface of the sheet with the reading surfaces of front and back surfaces of the document aligned in vertical and horizontal directions and without reduction in size, based on pieces of the image data of the reading surfaces of the front and back surfaces of the document.

10. A control method for an image forming apparatus, the image forming apparatus including:
a printer that performs printing on a sheet based on image data of a reading surface of a document as a reading target in printing; and
a notification provider that provides notification of print settings information, the print settings information being settable in the printer, the control method comprising:
determining whether sheet-reduction printing is settable in the printer, the sheet-reduction printing meaning a printing operation in which the number of sheets required in the printing by the printer is smaller than the number of reading surfaces based on character information related to character data in the image data; and
causing the notification provider to provide notification of the print settings information related to the settable sheet-reduction printing in a case where setting of the sheet-reduction printing is determined to be possible.
